(19) United States
(12) Patent Application Publication
(10) Pub. No.: US 2003/0198706 A1
(43) Pub. Date: Oct. 23, 2003

(54) Ice-cream disher

(76) Inventor: Sun Kwan Kim, Incheon-shi (KR)

Correspondence Address: LATHROP & GAGE LC, 2345 GRAND AVENUE, SUITE 2800, KANSAS CITY, MO, 64108, US

(21) Appl. No.: 10/228,648

(22) Filed: Aug. 26, 2002

(30) Foreign Application Priority Data
Apr. 18, 2002 (KR) 20-2002-11745

(51) Int. Cl. A23G 1/20

(52) U.S. Cl. 425/187; 425/285

(57) ABSTRACT

The present invention relates to an ice-cream disher, which is easy to manufacture, and which can scoop out a certain amount of ice-cream stored in an ice-cream drum. It is an ice-cream disher, which comprises a hemispherical scooping bowl; a connecting member, extending to one side, which is attached to the scooping bowl; a handle joined to the connecting member; and a scooping means, comprising fixing to the support plate a rotation-axis rod with a gear for enabling semi-rotation of the scooping tongue within the scooping bowl, and fitting a lever having a working plate onto the clamp pin by way of a spring, which is in gear with the gear, wherein the attachment construction of the connecting member to the handle comprises inserting the rear end into the insertion groove formed at the frontal end of the handle, and then forcibly inserting a clamp pin into the pin holes formed in the vertical direction of the connecting member and the handle.

### RELATED APPLICATIONS

This application claims priority to Korean Utility Application No. 20-2002-11745, filed Apr. 18, 2002, which is expressly incorporated herein by reference.

### FIELD OF THE INVENTION

The present invention relates to an ice-cream disher, which can scoop out a certain amount of ice-cream stored in an ice-cream drum, or more particularly to an ice-cream disher, which allows easy assembly of components therein.

### BACKGROUND OF THE INVENTION

A conventional ice-cream disher, as illustrated in FIGS. 1 and 2, comprises an ice-cream scooping bowl 1, one side of which is fixed to one end of a handle-connecting rod 2 having a support plate 3, thereby forming a juncture 4, the gap of which is treated with a coat of epoxy resin; and a working plate 5, having an assembly of a lever 6 and a multiple of gear grooves 7, which is then fixed onto the upper side of the handle-connecting rod 2 along with a spring 8 by way of a screw 9 for supporting the working plate, wherein the spring 8, to one side, is caught onto the inner side of the lever 6, and the other side is caught onto the support plate 3.

Moreover, the present invention comprises an ice-cream scooping bowl 1, the inside of which is equipped with a scooping tongue 10; and a rotation-axis rod 11 with a gear 12, one end of which is bored into the scooping bowl 1 in a manner to allow rotation and welded to the scooping tongue 10 with tin at the welding zone 13, and the other end of which is connected in a manner to allow rotation to the upper part of the support plate 3.

Moreover, the handle 14 comprises a hollow space therein, into which a screw 15 is inserted for attachment of the handle. Then, the handle 14 is screwed into the rear end of the connecting rod 2.

With respect to the ice-cream disher as constructed above, if the lever 6 is pulled inward, the spring 8 contracts while moving the gear grooves 7 formed on the working plate 5. At that time, since the gear 12 is in gear with the gear grooves 7, the gear 12 rotates as the gear grooves 7 move, thereby rotating the rotation-axis rod 11 in unit with the gear 12, and then the ice-cream scooping tongue 10. Accordingly, after scooping the ice-cream into the ice-cream scooping bowl 1, while transferring it to another vessel, by pulling onto the lever 6, the scooping tongue 10 comes in contact with the inner surface of the scooping bowl 1 while rotating therein. As such, it allows easy dishing of ice-cream onto another vessel.

By welding the welding zone 13 with tin, which is harmless to human, the conventional disher eliminates the problem of a harmful lead component from welding. Further, by coat-treating with harmless epoxy resin the juncture 4 of the scooping bowl 1 and the connecting rod 2, it is hygienic by way of preventing sticking of foreign substances therein and inhabitation of germs. Further, since its rotation-axis rod 11 and the gear 12 are molded into a unit, the conventional disher is practical without malfunction even in long-term usage.

However, in the conventional disher, the working plate 5 and the spring 8 are supported by means of screwing a screw for supporting the working plate into the connecting rod 2. This poses a problem of taking long assembly time since it involves screwing in the screw 9 for supporting the working plate.

With respect to the conventional disher, it further involves long assembly time, in case of attaching the handle 14 to the connecting rod 2, since it entails assembly by screwing a screw after inserting in place the screw 15 for attachment of the handle through the hollow space formed inside the handle 14. It also is an inconvenient operation of inserting in place the screw 15 for attachment of the handle through the hollow space formed inside the handle 14.

In order to overcome the disadvantages relating to the assembly of a handle 14 to the connecting rod 2, the recent modification presents a method of molding into an integrated unit, which comprises installing a screw 15 for attachment of the handle onto the mold at the time of injection-molding the handle. However, this method accompanies a process of installing a screw 15 for attachment of the handle to the mold and also is problematic in that it is accident-prone possibly resulting in severed fingers of workers while manual installation inside the mold.

### SUMMARY OF THE INVENTION

In consideration of the problems of the conventional disher, the objective of the present invention lies in providing an ice-cream disher, which allows assembly by joining with a pin instead of a screw for supporting the working plate of the conventional disher, and at the same time offers easy assembly by joining the connecting rod to the handle with the same pin.

In order to achieve the technical objective, an ice-cream disher according to the present invention comprises a scooping bowl; a connecting member, extending to one side, which is attached to the scooping bowl; a handle joined to the connecting member; and a scooping means for separating ice-cream within the scooping bowl, wherein the connecting member, with its rear end being inserted into the insertion groove formed at the frontal end of the handle, is joined in place by forcibly inserting a clamp pin into the pin holes formed in the vertical direction of the connecting member and the handle.

Moreover, the ice-cream disher according to the present invention further comprises a connecting member, which has an adhesion plate attached to the outer surface of the scooping bowl, and a connecting ridge, in which the frontal end thereof is riveted to the juncture groove formed at the rear end of the adhesion plate.

Moreover, the ice-cream disher according to the present invention further comprises a handle, having a hollow space inside the rear end thereof, which is finished off by inserting thereto a cap having a hanger hole at its tail end.

Moreover, the ice-cream disher according to the present invention further comprises a scooping means, which includes a scooping tongue, which semi-rotates within the scooping bowl; a rotation-axis rod with a gear, which is connected to the scooping tongue; a support plate formed on the handle, which props up the rotation-axis rod; a working plate, having gear grooves in gear with the gear, which is hinged to one side thereto; and a lever, which is connected to the working plate and is restored by way of a spring.

### BRIEF DESCRIPTION OF THE DRAWINGS

FIG. 1 is a perspective view of a conventional ice-cream disher.

FIG. 2 is a sectional view of a conventional ice-cream disher.

FIG. 3 is a perspective view of an ice-cream disher according to the present invention.

FIG. 4 is a plain view of an ice-cream disher according to the present invention.

FIG. 5 is a sectional view of an ice-cream disher according to the present invention.

FIG. 6 is a dissembled sectional view of main components of an ice-cream disher according to the present invention.

FIG. 7 is an enlarged sectional view of main components of an ice-cream disher according to the present invention.

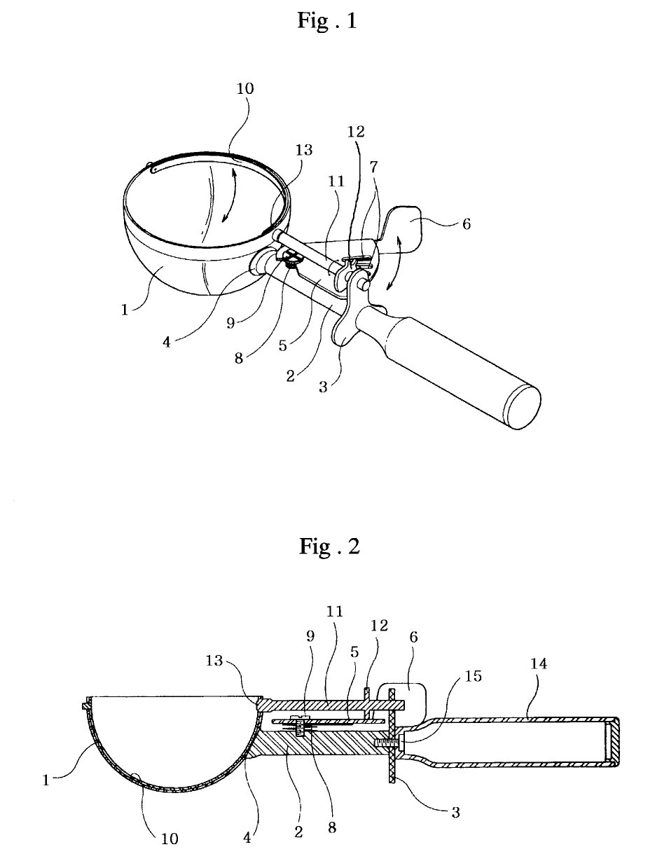

### DESCRIPTION OF THE PREFERRED EMBODIMENTS

Below, the present invention is described in further detail by way of attached drawings and examples.

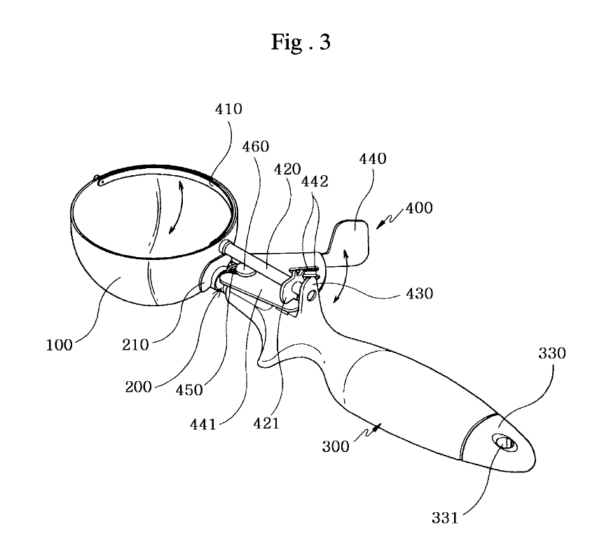

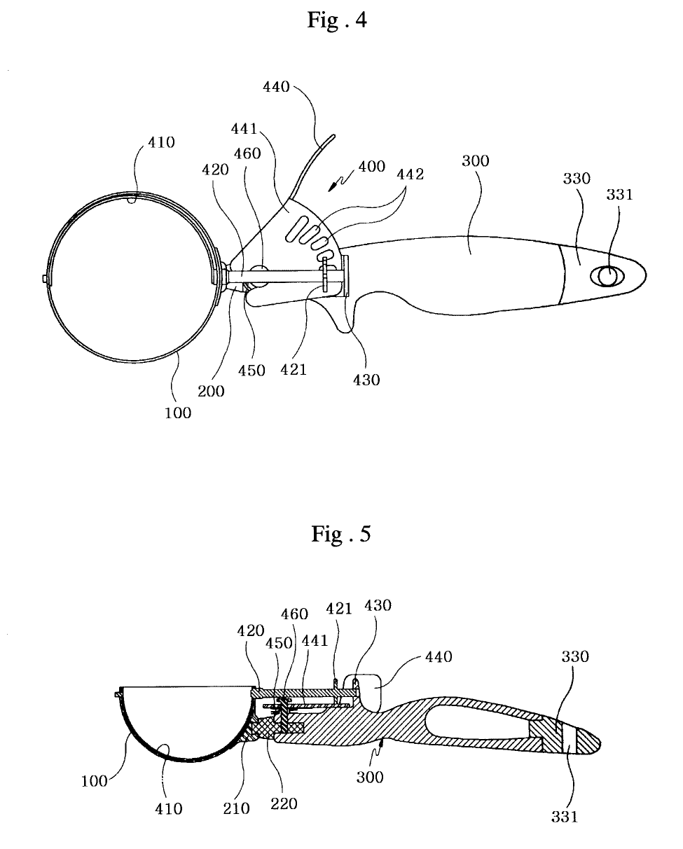

FIG. 3 is a perspective view of an ice-cream disher according to the present invention. FIG. 4 is a plain view of an ice-cream disher according to the present invention. FIG. 5 is a sectional view of an ice-cream disher according to the present invention.

An ice-cream disher according to the present invention comprises a scooping bowl 100, a connecting member 200, a handle 300, and a scooping means 400.

The scooping bowl 100, shaped in the form of a hemisphere, is a bowl, which scoops up ice-cream.

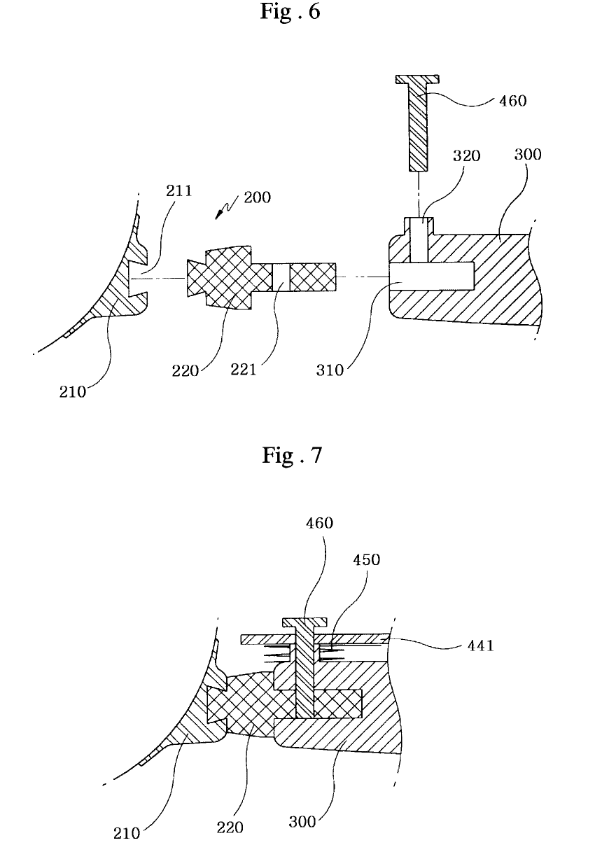

The connecting member 200 is attached to one side of the outer surface of the scooping bowl, and its other end is attached to the handle 300. The attachment construction of the connecting member 200 to the handle 300 is as follows: the rear end of the connecting member 200, being inserted into a insertion groove 310 formed at the frontal end of the handle 300, is joined in place by forcibly inserting a clamp pin 460 into a pin holes (221, 320) formed in the vertical direction of the connecting member 200 and the handle 300. Here, the clamp pin 460 has the role of joining the connecting member 200 to the handle 300 while at the same time propping up a working plate 441 of the scooping means 400, and a spring 450 (refer to FIGS. 6 and 7).

Accordingly, with respect to the assembly of a connecting member 200 to the handle 300, it is a simple assembly, which involves first inserting the rear end of the connecting member 200 into the insertion groove 310 formed at the frontal end of the handle 300 and then forcibly inserting the clamp pin 460 into the pin holes (221, 320) formed in the vertical direction of the connecting member 200 and the handle 300. In other words, while the conventional process involves screwing two screws therein, in the present invention, it is accomplished by wedging only one pin. Moreover, in contrast to the long extended connecting member of the conventional device, the present invention is equipped with a short one, which in the end offers reduction of material costs.

Meanwhile, as shown in FIGS. 6 and 7, the connecting member 200 comprises an adhesion plate 210, attached to the outer surface of the scooping bowl 100, and a connecting ridge 220, in which the frontal end thereof is riveted to a juncture groove 211 formed at the rear end of the adhesion plate 210. Here, the attachment process is simple one: the adhesion plate 210 is spot-welded to the outer surface of the scooping bowl 100, and the connecting member 200 is riveted to the juncture groove 211 formed at the rear end of the adhesion plate 210.

The frontal end of the handle 300 is joined to the connecting member 200 by way of the pin 460; and a support plate 430, propping the rotation-axis rod 420 of the scooping means 400, is integrated into the middle portion of the handle 300. In contrast to the handle of the conventional disher assembled with separate components, the handle 300 of the present invention presents simplicity in assembly with structural durability due to since it is injection-molded as an integrated unit. Moreover, the rear end of the handle 300, having a hollow space inside, is finished off by inserting thereto a cap 330 having a hanger hole 331 at its tail end. The finish process offers reduction in material costs and confers lightness to the disher.

The scooping means 400, which separates the ice-cream scooped into the scooping bowl 100, comprises a scooping tongue 410, which semi-rotates within the scooping bowl 100; the rotation-axis rod 420 with a gear 421, which is connected to the scooping tongue 410; the support plate 430, integrated onto the handle 300, which props up the rotation-axis rod 420; the working plate 441, having gear grooves 442 in gear with the gear 421, which is hinged to one side thereto; and a lever 440, which is connected to the working plate 441 and is restored by way of a spring 450.

Here, the support plate 430 is integrated into the handle 300. In contrast to the support plate of the conventional device assembled with separate components, it is injection-molded in an integrated unit with a handle, thereby simplifying its assembly process and doing away with keeping an inventory of components by reducing the number of components.

With respect to the scooping means 400, as for separating the ice-cream scooped into the scooping bowl 100, by pulling the lever 400 to one side, the scooping tongue 410 semi-rotates within the scooping bowl 100, thereby separating the ice-cream therefrom. This type of operation is not much different from that of the conventional disher, and the detail description thereof is omitted herein.

By means of first inserting the rear end of the connecting member 200 into the insertion groove 310 formed at the frontal end of the handle 300 and then forcibly inserting a clamp pin 460 into the pin holes (221, 320) formed in the vertical direction of the connecting member 200 and the handle 300, the ice-cream disher according to the present invention as above has the effect of simplifying the assembly process of the connecting member to the handle.

Further, by means of integrating with a handle a support plate which props up the rotation-axis rod having an attachment of a gear, the present has the effect of simplifying its assembly process and doing away with an inventory of components by reducing the number of components.

What is claimed is:

1. An ice-cream disher, comprising a hemispherical scooping bowl 100; a connecting member 200 having a rear end extending to one side and a vertically oriented pin hole 221 formed therein, the connecting member 200 being attached to the scooping bowl; a handle 300, joined to the connecting member 200 and having a frontal end with an insertion groove 310 and a vertically oriented pin hole 320 formed therein; and a scooping means 400 for separating ice-cream within the scooping bowl 100, wherein the connecting member 200 and handle 300 are joined by insertion of the connecting member rear end into the insertion groove 310 of the handle 300 and forcible insertion of a clamp pin 460 into the pin holes (221, 320) formed in the connecting member 200 and the handle 300.

2. The ice-cream disher according to claim 1, wherein the connecting member 200 comprises an adhesion plate 210, attached to the outer surface of the scooping bowl 100, and a connecting ridge 220, in which the frontal end thereof is riveted to a juncture groove 211 formed at the rear end of the adhesion plate 210.

3. The ice-cream disher according to claim 2, wherein the handle 300 has a rear end and a hollow space formed therein, which is finished off by inserting thereto a cap 330 having a hanger hole 331 formed proximal to a tail end of the cap 330.

4. The ice-cream disher according to claim 2, wherein the scooping means 400 comprises a scooping tongue 410, which semi-rotates within the scooping bowl; a rotation-axis rod 420 with a gear 421, which is connected to the scooping tongue 410; a support plate 430, formed onto the handle 300, which props up the rotation-axis rod 420; a working plate 441, having gear grooves 442 in gear with the gear 421, which is hinged to one side thereto; and a lever 440, which is connected to the working plate 441 and is restored by way of a spring 450.

5. The ice-cream disher according to claim 1, wherein the handle 300 has a rear end and a hollow space formed therein, which is finished off by inserting thereto a cap 330 having a hanger hole 331 formed proximal to a tail end of the cap 330.

6. The ice-cream disher according to claim 1, wherein the scooping means 400 comprises a scooping tongue 410, which semi-rotates within the scooping bowl; a rotation-axis rod 420 with a gear 421, which is connected to the scooping tongue 410; a support plate 430, formed onto the handle 300, which props up the rotation-axis rod 420; a working plate 441, having gear grooves 442 in gear with the gear 421, which is hinged to one side thereto; and a lever 440, which is connected to the working plate 441 and is restored by way of a spring 450.
